(19) United States
(12) Patent Application Publication
(10) Pub. No.: US 2015/0309068 A1
(43) Pub. Date: Oct. 29, 2015

(54) DEVICE AND METHOD FOR MONITORING OPERATIONS OF ELECTRONIC DEVICE

(71) Applicants: HONGFUJIN PRECISION ELECTRONICS (ZHENGZHOU) CO.,LTD., Zhengzhou (CN); HON HAI PRECISION INDUSTRY CO., LTD., New Taipei (TW)

(72) Inventors: YU-CHING LIU, New Taipei (TW); FU-CHI YANG, New Taipei (TW); SHUN-TUNG CHEN, New Taipei (TW); WEI-DA YANG, New Taipei (TW); PO-LIN SU, New Taipei (TW); GUANG-JUN ZHU, Shenzhen (CN)

(21) Appl. No.: 14/678,541

(22) Filed: Apr. 3, 2015

(30) Foreign Application Priority Data
Apr. 28, 2014 (CN) 201410174291.6

(51) Int. Cl. G01P 15/00; G01P 15/14

(52) U.S. Cl. CPC G01P 15/00; G01P 15/14

(57) ABSTRACT

A method for monitoring operations of an electronic device is provided. The method includes: determining, at the electronic device, a data range of standard operations of the electronic device; storing, at the electronic device, the data range; obtaining, at the electronic device, motion data of the electronic device when the electronic device is in operation; determining, at the electronic device, whether the motion data is within the data range; and outputting, at the electronic device, an alert message representing current operation of the electronic device is unsatisfactory if the motion data is not within the data range.

### FIELD

The subject matter herein generally relates to a method and device for monitoring operations of an electronic device.

### BACKGROUND

Electronic devices, for example smart phones, portable PCs, or tablet PCs, have been used with increasing popularity worldwide for a variety of personal and business uses. The electronic devices are generally produced by efficient assembly line. The assembly line production process involves assembly, testing, and packaging, each of which requires correct operation. Therefore, a method for monitoring user operation of the assembly line is needed.

### BRIEF DESCRIPTION OF THE DRAWINGS

Implementations of the present technology will now be described, by way of example only, with reference to the attached figures.

FIG. 1 is a diagrammatic view of an exemplary embodiment of an electronic device.

FIG. 2 is a flowchart of an exemplary embodiment of a method for monitoring operations of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

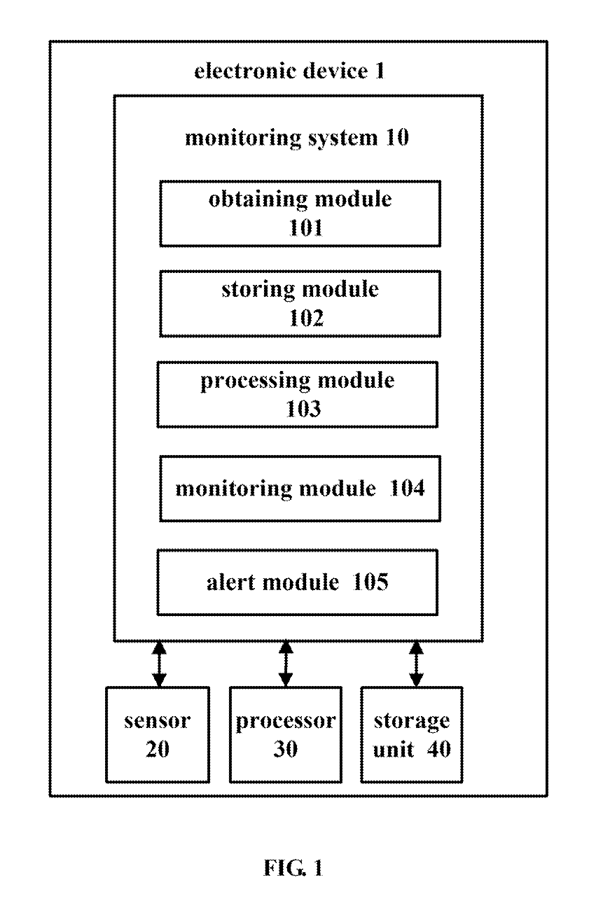

FIG. 1 illustrates a diagrammatic view of an exemplary embodiment of an electronic device 1. In the example embodiment, the electronic device 1 can be a smart phone, a portable computer, a tablet PC, or other electronic device capable being produced by assembly lines. The electronic device 1 can include, but not limited to, a sensor 20, a processor 30, and a storing unit 40. The sensor 20 can be configured to detect motion of the electronic device 1. The sensor 20 can be a three-axis gyroscope, or a Z-axial acceleration sensor. The processor 30 can be a central processing unit (CPU), a microprocessor, or other data processor chip that performs functions of the electronic device 1. The storage unit 40 can be a storage system, such as a hard disk, a storage card, or a data storage medium. In at least one embodiment, the storage unit 40 can include two or more storage devices such that one storage device is a memory and the other storage device is a hard drive. Additionally, one or more of the storage devices can be located external relative to the electronic device 1.

A monitoring system 10 can include computerized instructions in the form of one or more programs that are executed by the processor 30 and stored in the storage unit 40. The system 10 can include one or more modules, for example, a detecting module 101, a obtaining module 102, a storing module 103, a processing module 104, a monitoring module 105, and an alert module 106. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The obtaining module 101 can be configured to obtain motion data from the sensor 20. The motion data can be Z axis acceleration of the electronic device or three axis's acceleration of the electronic device. The storing module 102 can be configured to stores a data range in relation to standard operations. The processing module 103 can be configured to configure a data range in relation to standard operations. In at least one embodiment, the processing module 103 can configure the data range in relation to standard operation based on statistical analysis of motion data under one or more standard operations. The monitoring module 104 can be configured to determine whether current motion data falls into the data range in relation to standard operations. The alert module 105 can be configured to issue an alert message when current motion data is beyond the data range in relation to standard operations.

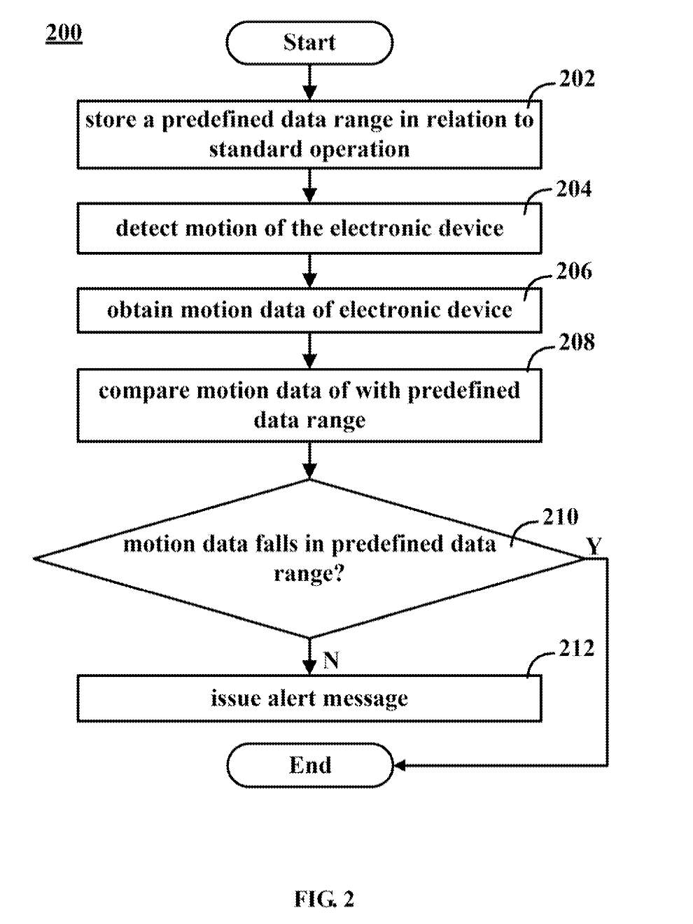

Referring to FIG. 2, a flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 2 represents one or more processes, methods or subroutines, carried out in the exemplary method 200. Furthermore, the illustrated order of blocks is by example only and the order of the blocks can change according to the present disclosure. Additional blocks may be added or fewer blocks may be utilized, without departing from this disclosure. The exemplary method 200 for monitoring operations of an electronic device is illustrated in FIG. 2. The exemplary method 200 can begin at block 202.

At block 202, the electronic device stores a data range in relation to standard operations. For example, according to the standard operation, the electronic device should be handled gently. In order to reach requirement of “gently”, the acceleration of the electronic device should fall into a predefined data range. The sensor 20 can be a three-axis gyroscope, or a Z-axial acceleration sensor. The data range in relation to standard operations can be configured by a user input. In at least one embodiment, the data range in relation to standard operations can be calculated based on statistical analysis motion data of electronic device which is operated correctly. In detail, the electronic device detects motion of the electronic device and obtains motion data under a plurality of standard operations. Then, the electronic device determines a data range in which the motion data falls. The data range in which the motion data falls can be configured as the data range in relation to standard operations. For example, if the electronic device has a Z axis sensor configured to detect motion of the electronic device and the Z axis acceleration of the electronic device obtained by the Z axis sensor is a1˜a4 when the electronic device is operated correctly according to operation standards, the data range in relation to standard operations can be configured as a1˜a4.

At block 204, the electronic device detecting motion of the electronic device by at least one sensor of the electronic device.

At block 206, the electronic device obtains motion data, for example, current acceleration of the electronic device, every scheduled time, for example, every 5 seconds.

At block 208, the electronic device compares the motion data to the predetermined data range.

At block 210, the electronic device determines whether the motion data falls into the predetermined data range. If the motion data falls into the predetermined data range, the process goes to an end, otherwise, the process goes to block 212.

At block 212, the electronic device issues an alert message which can be in a form of text, light, voice or vibration. The alert message can be configured to indicate that current operation of the electronic device is not qualified.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for monitoring operations of an electronic device, comprising:
determining, at the electronic device, a data range of standard operations of the electronic device;
storing, at the electronic device, the data range;
obtaining, at the electronic device, motion data of the electronic device when the electronic device is in operation;
determining, at the electronic device, whether the motion data is within the data range; and
outputting, at the electronic device, an alert message representing current operation of the electronic device is unsatisfactory if the motion data is not within the data range.

2. The method according to claim 1, further comprising:
obtaining, at the electronic device, motion data of the electronic device under standard operations;
determining, at the electronic device, a data range in which the motion data of the electronic device under standard operations falls; and
configuring, at the electronic device, the determined data range as standard operations of the electronic device.

3. The method according to claim 1, wherein the alert message is in a form of text, voice, light or vibration.

4. The method according to claim 1, wherein the motion data is Z axis acceleration.

5. The method according to claim 1, wherein the motion data is three axis's acceleration.

6. An electronic device, comprising:
a sensor configured to detect motion of the electronic device;
a storage unit configured to store instructions;
a processor for executing the instructions that causes the processor to:
configure a data range of standard operations;
store the data range;
obtain motion data of the electronic device when the electronic device is in operation;
determine whether the motion data is within the data range; and
issue an alert message representing current operation of the electronic device is unsatisfactory if the motion data is not within the data range of standard operations.

7. The device according to claim 6, wherein “configure a data range of standard operations of the electronic device” causes the processor to:
obtain motion data of the electronic device under standard operations;
determine a data range in which the motion data of the electronic device under standard operations falls; and
configure the determined data range as standard operations of the electronic device.

8. The device according to claim 6, wherein the alert message is in a form of text, voice, light or vibration.

9. The device according to claim 6, wherein the sensor is a Z axis acceleration sensor, and the motion data is Z axis acceleration.

10. The device according to claim 6, wherein the sensor is a three axis's acceleration sensor, and the motion data is three axis's acceleration.
